(19) United States
(12) Patent Application Publication
(10) Pub. No.: US 2019/0079946 A1
(43) Pub. Date: Mar. 14, 2019

(54) INTELLIGENT FILE RECOMMENDATION

(71) Applicant: Microsoft Technology Licensing, LLC, Redmond, WA (US)

(72) Inventors: Karvell Ka Yiu Li, Bellevue, WA (US); Yi-Lei Wu, Sammamish, WA (US); Rui Hu, Redmond, WA (US); Sharon Hang Li, Redmond, WA (US); Sihong Liu, Kirkland, WA (US); Si-Qing Chen, Bellevue, WA (US); Ankita Sharma, Palo Alto, CA (US); Varshini Ramaseshan, Bangalore (IN); Tejprakash S. Gill, Bellevue, WA (US); Tomasz Lukasz Religa, Seattle, WA (US)

(21) Appl. No.: 15/702,996

(22) Filed: Sep. 13, 2017

(51) Int. Cl. G06F 17/30; G06N 99/00; H04L 29/08

(52) U.S. Cl. CPC G06F 17/30132; G06F 3/04817; H04L 67/2842; G06N 99/005

(57) ABSTRACT

In example embodiments, a server stores, in one or more data repositories, a plurality of files that are accessible to a first user of a client device. The server computes, for each file in the plurality of files, a score representing a likelihood that the first user will access the file. The server determines that, for one or more files from the plurality of files, the score exceeds a threshold. The server caches the one or more files in a local cache memory of the client device in response to determining that the score exceeds the threshold.

### BACKGROUND

Downloading a file from an online data store or local long-term storage at a client device may be a time-consuming process. To optimize this process, the client device may include a cache, which stores a smaller number of files for quick access. Optimizing the files stored in the cache may be desirable.

### BRIEF DESCRIPTION OF THE DRAWINGS

Some embodiments of the technology are illustrated, by way of example and not limitation, in the figures of the accompanying drawings.

FIG. 1 illustrates an example system in which intelligentfile recommendation may be implemented, in accordance with some embodiments.

FIG. 2 is a flow chart illustrating an example method for intelligent file recommendation, in accordance with some embodiments.

FIG. 3 is a flow chart illustrating an example method of using machine learning for intelligent file recommendation, in accordance with some embodiments.

FIG. 4 is a data flow diagram for intelligent file recommendation, in accordance with some embodiments.

FIG. 5 is a block diagram illustrating components of a machine able to read instructions from a machine-readable medium and perform any of the methodologies discussed herein, in accordance with some embodiments.

### SUMMARY

The present disclosure generally relates to machines configured for intelligent file recommendation, including computerized variants of such special-purpose machines and improvements to such variants, and to the technologies by which such special-purpose machines become improved compared to other special-purpose machines that provide technology for file recommendation. In particular, the present disclosure addresses systems and methods for intelligent file recommendation.

According to some aspects, a machine stores, in one or more data repositories, a plurality of files that are accessible to a first user of a client device. The machine computes, for each file in the plurality of files, a score representing a likelihood that the first user will access the file. The machine determines that, for one or more files from the plurality of files, the score exceeds a threshold. The machine caches the one or more files in a local cache memory of the client device in response to determining that the score exceeds the threshold.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

As noted above, downloading a file from an online data store (e.g., remote storage or cloud storage) or local long-term storage at a client device may be a time-consuming process. To optimize this process, the client device may include a cache, which stores a smaller number of files for quick access. Optimizing the files stored in the cache may be desirable. Some aspects of the technology described herein are directed to an intelligent file recommendation technique, which optimizes the files stored in the cache based, for example, on the files that are predicted to be accessed by the user of the client device.

According to some aspects, a server stores, in one or more data repositories (for example, the long-term storage of a client device and an online data store), a plurality of files that are accessible to a first user of a client device. The server computes, for each file in the plurality of files, a score representing a likelihood that the first user will access the file. The score is computed based on one or more of: (i) interactions between the first user and one or more second users, (ii) activity of the one or more second users with the file, (iii) a device-type of the client device, and (iv) a time of day and day of the week. The server determines that, for one or more files from the plurality of files, the score exceeds a threshold. The server caches the one or more tiles in a local cache memory of the client device in response to determining that the score exceeds the threshold.

Advantageously, as a result of some aspects of the technology described herein, files that have a high likelihood of being accessed by the first user are stored in the cache of the client device, rather than only being stored in the long-term storage of the client device or in the online data store. Thus, the user is able to more quickly open files that he/she is likely to access, resulting in a better user experience.

As used herein, the term “file” encompasses its plain and ordinary meaning. In addition, a file may include any electronic data stored at a machine for example, a word processing document or a spreadsheet. The term “file” is not limited to any type, structure, or arrangement of data. As used herein, the terms “file” and “document” are interchangeable.

Online data stores, which store files, are used for collaboration and productivity. However, there are two challenges when working with online data stores—performance and file discovery/exploration.

Regarding the performance challenge, an online data store is often not geo-distributed to support globally distributed teams. Thus, users who are located outside the storage region, may suffer from network latencies when trying to open files and collaborate online. Such issues can impact the team's productivity. Some aspects of the technology described herein use machine learning techniques combined with a productivity social graph to enable local caching of files that users are likely to open. This may improve performance when users try to open files from the online data store. As used herein, the phrase “storage region” encompasses its plain and ordinary meaning. In some cases, the world may be divided into multiple storage regions from which tiles may be accessed. The storage regions may correspond, for example, to continents, countries, or jurisdictional or other divisions within countries (e.g., states, provinces or metropolitan areas). A client device located within a storage region where a given file is stored may be able to more quickly access the given file than a client device located outside the storage region. For example, if the storage regions correspond to continents, a client device in France (which is in the continent Europe) may be able to more quickly download and open a file stored at an online data store in Germany (which is also in Europe) than a client device in Brazil (which is in the continent South America) may be able to open and download the same file. In some cases, a storage region of a given client device may correspond to a geographic area within a predefined threshold distance (e.g., 200 km or 300 km) of a geographic location where the given client device was last online.

Regarding the file discovery/exploration challenge, a user may use search to find and discover the files in which the user is interested. Some aspects of the technology described herein may be used to recommend the files that are interesting to the users. Some aspects use machine learning, based on the user's past activity, social networking activity, and the like to determine the files that are most relevant to the user. The technology described herein, in some aspects, caches recommended files to provide fast access to the files.

In some aspects, the technology described herein leverages an “influencer network” that can identify the influencers in different types of user networks for predicting the tiles that are most likely to be opened by the user. The influencer network is constructed by computing collaboration relationships based on user pairs' activities on shared documents, emails, meetings, instant messages and the like. The users influencers) who drive the most collaboration are identified. At the end of the computation, an influence score is assigned to each individual user in the network. The higher the score, the more collaborative the associated user is. The scores will then be used, collectively, to inform what files should be stored in cache and in what priority. In some aspects, the technology described herein caches the files that are likely to be opened by the user locally on the user's client device to achieve faster file opening. In this manner, some aspects of the technology described herein utilize not only a content delivery network (CDN), but also local caching.

### Example Implementations

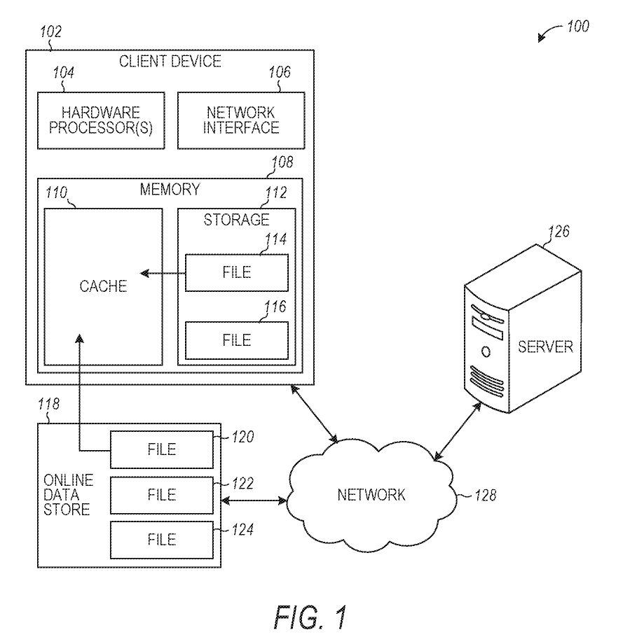

FIG. 1 illustrates an example system 100 in which intelligent file recommendation may be implemented, in accordance with some embodiments. As shown, the system 100 includes a client device 102, an online data store 118, and a server 126. The client device 102, the online data store 118, and the server 126 communicate with one another over a network 128. The network 128 may include one or more of the Internet, an internet, a local area network, a wide area network, a wired network, a wireless network, and the like. The client device 102 may be a laptop computer, a desktop computer, a mobile phone, a tablet computer, a smart watch, a smart television, a personal electronic music player, a personal digital assistant (PDA), and the like.

As shown, the client device 102 includes hardware processor(s) 104, a network interface 106, and a memory 108. The hardware processor(s) 104 may include one or more hardware processors configured into one or more processing units, such as a central processing unit (CPU), a graphics processing unit (GPU), and the like. The hardware processor(s) are capable of executing machine-readable instructions, which may be stored in a machine-readable medium, such as the memory 108 or another machine-readable medium. The network interface 106 allows the client device 102 to transmit and receive data over the network 128.

The memory 108 of the client device 102 stores data and/or instructions. As shown, the memory 108 includes a cache 110 and a storage 112. The cache 110 may be smaller than the storage 112. The cache 110 is configured for fast access by the hardware processor(s) 104, and the storage 112 is configured to store more data and/or instructions for slower access. In some examples, the cache 110 is a random access memory (RAM) cache, and the storage 112 is distinct from the cache 110. As shown, the storage 112 includes two files 114 and 116, which may be copied to the cache 110 for faster access to those files. As illustrated, the file 114 is being copied from the storage 112 to the cache 110. While the storage 112 is illustrated here as storing only two files 114 and 116, in some cases, the storage 112 may store a larger number of files (e.g., hundreds or thousands of tiles).

The online data store 118 stores files 120, 122, and 124 remotely from the client device 102. The client device 102 accesses the online data store 118 and the files 120, 122, and 124 stored there via the network 128. The files 120, 122, and 124 may occasionally be accessed by the client device 102, and may be copied to the cache 110 of the client device 102 (as shown for file 120) if those files are expected to be accessed, at the client device 102, in the future. As shown, the online data store 118 stores three files 120, 122, and 124. However, in some implementations, the online data store 118 may store thousands or even millions of files.

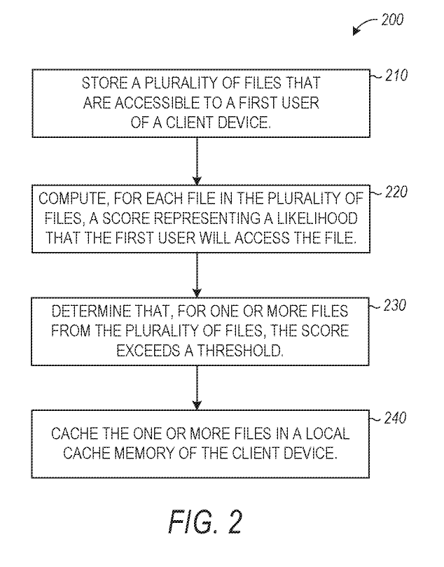

The server 126 computes, for each file in the plurality of files 114, 116, 120, 122, and 124 residing at the storage 112 or the online data store 118, a score representing a likelihood that a first user of the client device 102 will access the file. The score is computed based on one or more of: (i) interactions between the first user and one or more second users, (ii) activity of the one or more second users with the file, (iii) a device-type of the client device 102 (e.g., personal computer, mobile phone or tablet), and/or (iv) a time of day and day of the week. The server 126 determines that, for one or more files (e.g., files 114 and 120) from the plurality of files, the score exceeds a threshold. The one or more files may correspond to the n files with the highest score, where 11 is a predetermined positive integer. The server caches the one or more files in the cache 110 of the client device 102 in response to determining that the score exceeds the threshold. More details of example operations of the server 126 are described in conjunction with FIG. 2.

FIG. 2 is a flow chart illustrating an example method 200 for intelligent file recommendation, in accordance with some embodiments. The method 200 is described here as being implemented at the server 126 within the system 100. However, the method 200 may also be implemented in other systems or at other machines. The operations of the method 200, described below, may be implemented in any order. In some cases, one or more of the operations may be skipped or may be replaced with other operations.

At operation 210, the server 126 stores, in one or more data repositories (e.g., the storage 112 and the online data store 118), a plurality of files (e.g., files 114, 116, 120, 122, and 124) that are accessible to a first user of the client device 102 and to one or more second users (who may use different client devices from the client device 102). The first user may be a person or account associated with the client device 102. The one or more data repositories may include a data repository residing at the client device and a data repository residing remotely to the client device. The one or more data repositories may store, for example, files created by the first user, files shared with the first user, and files made accessible to the public.

At operation 220, the server 126 computes, for each file in the plurality of files, a score representing a likelihood that the first user will access the file (e.g., within the next threshold time period, such as one hour, two hours, or a day). The score may correspond to a probability. The score may be computed based on, among other factors, one or more of: (i) interactions between the first user and one or more second users, (ii) a social influencer score of the one or more second users, the social influencer score measuring a likelihood that the first user or other users access files associated with the one or more second users, (iii) activity of the one or more second users with the file, (iv) a device-type of the client device (e.g., people access different files from desktop computers and mobile phones and from business machines and personal machines), and/or (v) a time of day and day of the week (e.g., people access different files during business and non-business hours). The one or more second users may include business partners or collaborators of the first user, which are identified based on activities (e.g., accessing or editing common files) by both the first user and the one or more second users. The one or more second users may be identified based on email messages of the first user, social network contacts of the first user, or an electronic contact list (e.g., in a mobile phone or email application) of the first user. The interactions between the first user and the one or more second users may include both the first user and the one or more second users editing or commenting on one or more common files. The interactions between the first user and the one or more second users may include email messages between the first user and the one or more second users.

The score may be computed based on the social influencer score of the one or more second users associated with the file. A social influencer score may measure how influential one of the second users is on the first user in particular. For example, a second user whose files the first user always opens (e.g., the first user's boss in a business setting) may have a high social influencer score. A second user whose files the first user rarely or never opens (e.g., a junior member of a different team in a business setting) may have a low social influencer score. Alternatively, the social influencer score may measure how influential one of the second users is on other users in general. A celebrity whose files (e.g., shared through social media) are frequently opened may have a high social influencer score, while a less famous user whose files are only occasionally accessed by his/her closest contacts may have a low social influencer score.

In some aspects, machine learning is used to train the server 126 to compute the score for the files 114, 116, 120, 122, and 124. The server 126 accesses anonymized data of multiple first users accessing or not accessing multiple different files and additional information about the files, for example, the information about the past activity of the first user or the second users connected with the first user in connection with the file(s). The server applies machine learning techniques, such as random forest or decision trees to learn techniques for computing the score. In the training data, if a first user accesses a file, that file may be assigned a score of 1, and if the first user does not access the file, that file may be assigned a score of 0. Using this training set, the server 126 learns to compute scores between 0 and 1 representing the likelihood that a given first user will access a given file, based on information about the file.

Furthermore, during execution, as the first user accesses or fails to access file(s) 114, 116, 120, 122, and 124, the server 126 may learn about the habits of the first user and may tailor the machine learning accordingly this manner, the server 126 may learn specifically which files are accessed by which users. For example, one user may always open tiles that are emailed to him/her while another user may open video files that are shared with him/her but not word processing documents that are shared with him/her.

At operation 230, the server 126 determines that, for one or more files from the plurality of files, the score exceeds a threshold. In some cases, the one or more files may include the n files having the highest score, where n is a predetermined positive integer. In some cases, the one or more files may include files having at least a threshold file size (e.g., 50 kb or 100 kb), as smaller files may be quickly accessed from anywhere and do not necessarily need to be cached. In some cases, the email messages between the first user and the one or more second users include an attachment of or a hyperlink to at least one of the one or more files. It should be noted that the selected one or more files may include files previously opened by the first user, files not previously opened by the first user, files emailed to the first user, files shared with the first user, or files that are accessible to the first user but have not been emailed or shared with the first user.

At operation 240, the server 126 caches the one or more files in a local cache memory (e.g., cache 110) of the client device 102 in response to determining that the score exceeds the threshold (and, in some cases, that the file size is at least the threshold file size). Alternatively, the one or more files may be stored in an online data store within the same geographic region as the client device 102 (e.g., within a threshold distance of a geographic location where the client device 102 was last online or in the same continent, country, state or metropolitan area as the geographic location where the client device 102 was last online.) The server 126 may cache the one or more files while the client device 102 is idle or running another operation (e.g., editing a word processing document or displaying a page in a web browser). Thus, the first user might not notice that the one or more files are being cached until he/she attempts to open the file(s) and is able to do so more quickly than had the file(s) not been cached. The server 126 may cause the client device 102 to display (e.g., in a webpage or other display interface), to the first user, an icon representing each of the one or more files that had been cached. The first user may be presented with a suggestion to open the one or more files.

Some aspects of the technology described herein are directed to predicting the files that a user is likely to open. The predicted files are not limited to files opened in the past, but may also include files that the user has never opened before. A prediction algorithm may combine a collaboration network, which represents the collaboration relationships on files and emails between user pairs as well as file usage patterns in the network, and a knowledge network, which represents users' domain expertise inferred from the topics of the files that the user has authored. Various features computed from the two networks are then used to suggest files that are most relevant to user.

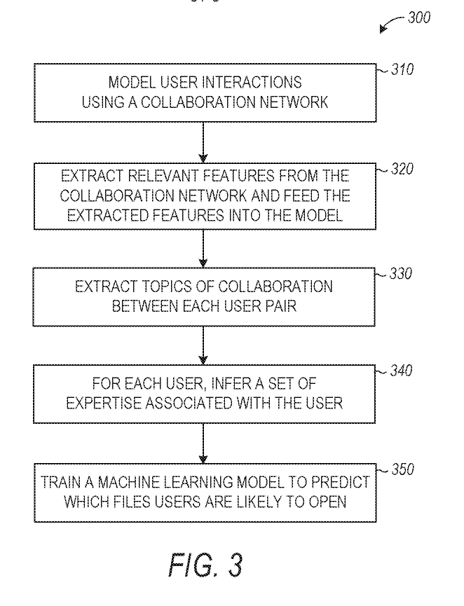

FIG. 3 is a flow chart illustrating an example method 300 of using machine learning for intelligent file recommendation, in accordance with sonic embodiments. The method 300 is described here as being implemented at the server 126 within the system 100. However, the method 300 may also be implemented in other systems or at other machines. The operations of the method 300, described below, may be implemented in any order. In some cases, one or more of the operations may be skipped or may be replaced with other operations.

At operation 310, the server 126 models user interactions using a collaboration network. In some cases, users are represented by nodes and their interactions are indicated by directed, weighted edges. The interactions include, but are not limited to, file sharing and editing, emails and instant message exchanges, meetings, and calendars.

At operation 320, the server 126 extracts relevant features from the collaboration network and feeds the extracted relevant features into the model. The features may include, but are not limited to, the following: file access features (e.g. number of times files edited/read by the user, number of times files edited/read by individuals in the user's immediate collaboration network (e.g. the user's contacts), weekly file usage pattern in the users' immediate (e.g. the user's contacts) or second level (e.g., contacts of the user's contacts) collaboration network), email collaboration features (e.g. files shared through emails), network collaboration features (e.g. number of neighbors, intensity of collaborations), and file trends.

At operation 330, the server 126 extracts topics of collaboration between each user pair, for example, by applying natural language processing and topic modeling algorithms (e.g. key phrase extractor or Latent Dirichlet Allocation (LDA)) to shared files, emails, and instant messages. These topics are stored in graphs along with the other features computed at operation 320.

At operation 340, the server 126, for each of at least a portion of the users in the network, infers a set of expertise associated with the user from various signals, such as the past files that the user has authored, edited or commented, the content of the user's email “sent” box, the topics of the user's past meetings or events, the past tasks that the user has completed, and the like. The server 126 then applies natural language processing techniques and topic modeling algorithms such as Microsoft's Key Phrase Extractor or Latent Dirichlet Allocation (LDA) to extract topics from natural language texts. Similar to the topics of collaboration, these expertise are also stored in the graphs as attributes of the user node.

At operation 350, the server 126 trains and validates a machine learning model to predict which files users are likely to open. The machine learning model is trained and validated using the variety of features derived from the operations 310-340. The machine learning model is trained to predict which files a given user is likely to open in the near future and to rank those files according to the estimated probabilities of opening by the given user. In some cases, the high probability (e.g., probability is greater than a threshold probability, such as 0.7 or 0.8) files are cached in advance for faster access by the given user. In some cases, the high probability files are recommended to the given user via a user interface. The machine learning model may be trained using either supervised or unsupervised learning techniques. In supervised learning techniques, the machine receives a set of files which were opened or not opened by users in the past. An opened file-user combination receives a score of 1 and an unopened file-user combination receives a score of 0. The machine is trained to predict scores for file-user combinations using this training set and the information about the files and the users described herein.

Aspects of the technology described herein include the algorithm to manifest the user network and to identify key influencing factors which predict whether a given user will open a given file. Aspects of the technology described herein include the architecture for making the machine learning model that can predict and rank the files most likely to be opened by the user. Aspects of the technology described herein include the client side intelligent file cache for downloading and managing the “most likely to be opened” files locally at the client device. Aspects of the technology described herein include the online user experience for getting a list of recommended files to open.

Some aspects of the technology described herein relate to gathering insights from user collaboration on documents and emails and identifying influencing factors which would help expand and intensify usage. One goal may be to provide a more effective and non-intrusive personalized experience. In some cases, recommendations for files may be presented at a time when the user is looking for documents to open and with “high accuracy” using accessible information.

Some aspects of the technology described herein relate to file recommendation. In some aspects, a file recommender is developed, which takes intro account multiple different signals, including document and email collaboration, organization reporting hierarchy, command usage patterns, and topics extracted from documents. The technology described herein allows the server 126 to recommend files that are relevant to the users. In some examples, the recommended files may be cached at the client device 102 for fast loading. Files may be suggested to a user based on the user's collaboration network and in a user interface displayed to the user. For new members in a given network, files may be suggested based on email and file-based signals. News or calendar events (e.g. conferences or talks) may be suggested based on domain expertise.

According to some aspects, the technology described herein uses email and document signals together instead of disjoint usage in some models. Moreover, the technology described herein not only recommends documents from the historically consumed pool but also suggests new content in the user's immediate network. The technology described herein may increase user engagement with online data stores or cloud computing in general.

Approaches of the technology described herein may be used to predict documents that the user is likely to open in near future, so that those documents can be cached in advance for faster access. The predicted documents will include not only the documents opened recently but also those that are relevant for possible future consumption.

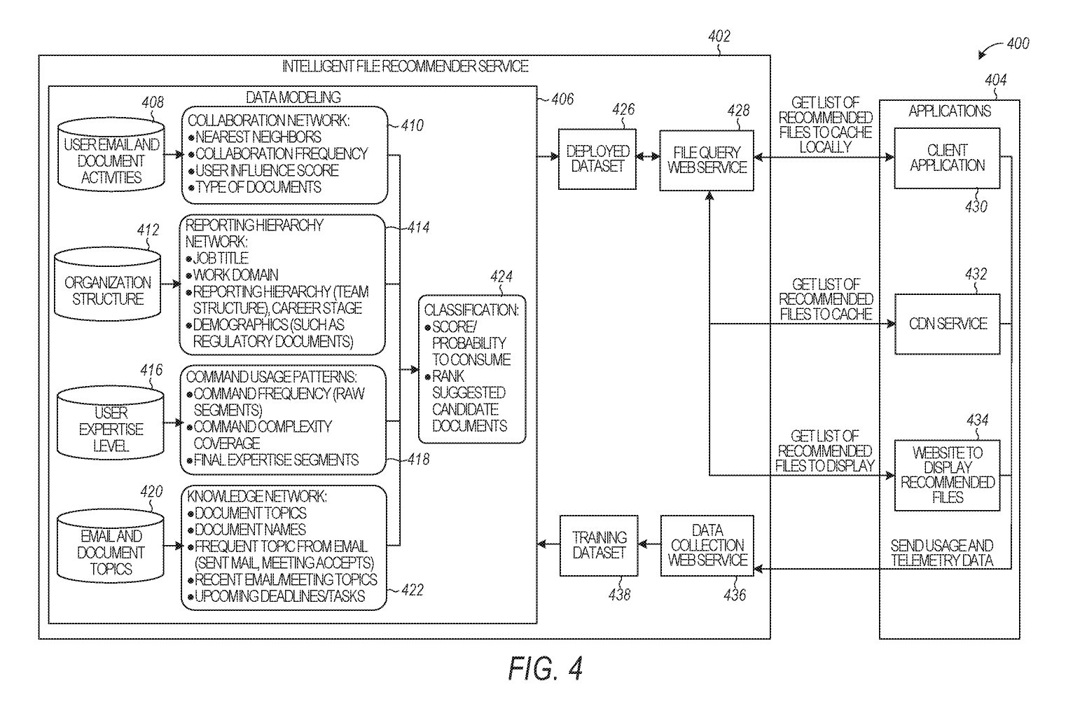

FIG. 4 is a data flow diagram 400 for intelligent file recommendation, in accordance with some embodiments. As shown, the data flow diagram 400 includes an intelligent file recommender service 402 and applications 404. The intelligent file recommender service 402 has a data modeling component 406.

The data modeling component 406 stores user email and document activities 408, organization structure 412, user expertise level 416, and email and document topics 420. The user email and document activities 408 are used to generate a collaboration network 410, which includes nearest neighbors, collaboration frequency, a user influence score, and a type of document. The organization structure 412 is used to generate a reporting hierarchy network 414, which includes a job title, a work domain, a reporting hierarchy (team structure), a career stage, and demographics (such as regulatory documents). The user expertise level 416 is used to generate command usage patterns 418, which include command frequency (raw segments), command complexity coverage, and final expertise segments. The email and document topics 420 are used to generate a knowledge network 422, which includes document topics, document names, frequency of topics from email (sent mail and meeting accepts), recent email/meeting topics, and upcoming deadlines/tasks. The collaboration network 410, the reporting hierarchy network 414, the command usage patterns 418, and the knowledge network 422 are combined into a classification 424. The classification 424 includes a score/probability of a user to open a document and a ranking of suggested candidate documents.

The data modeling component 406 communicates with a deployed dataset 426 of the intelligent file recommender service 402, which communicates with a file query web service 428 of the intelligent file recommender service 402. The file query web service 428 communicates with the applications 404. The applications 404 include client applications 430, a content delivery network (CDN) service 432, and a website to display recommended files 434. In some cases, instead of or in addition to displaying the recommended files at the website 434, the files may be downloaded to and/or cached at the client device 102 of the user. The file query web service 428 communicates a list of recommended files to cache locally with the client application 430. The file query web service 428 communicates a list of recommended files to cache (either locally at the client device or at a web server that is geographically proximate to the client device) with the CDN service 432. The file query web service 428 communicates a list of recommended files to display with the website to display recommended files 434.

The applications 404, including but not limited to, the client application 430, the CDN service 432 and the website to display recommended files 434, send usage and telemetry data (e.g., in real-time) to a data collection web service 436 of the intelligent file recommender service 402. Examples of the usage include a user opening a document, or a collaborator sharing a document with a given user. The data collection web service 436 generates a training dataset 438 of the intelligent file recommender service 402, which is used to further train/improve the data modeling 406. The deployed dataset 426 includes a list recommended documents for each user. The documents are computed based the data collected in the operations described above and are ranked based on the probability/score that the given user is likely to open a given document in the near future. The deployed dataset 426 is used to decide which documents should be cached and recommended when the applications 404 generate requests for documents.

### NUMBERED EXAMPLES

Certain embodiments are described herein as enumerated examples (A1, A2, A3, etc.). These enumerated examples are provided as examples only and do not limit the technology described herein.

Example A1 is a system comprising: one or more hardware processors; and a memory storing instructions which, when executed by the one or more hardware processors, cause the one or more hardware processors to perform operations comprising: computing, for each file in a plurality of files stored in one or more data repositories, a score representing a likelihood that a first user of a client device will access the file, the plurality of files being accessible to the first user and one or more second users, the score being computed based on at least: (i) interactions between the first user and the one or more second users, (ii) a social influencer score of the one or more second users, the social influencer score measuring a likelihood that the first user or other users access files associated with the one or more second users, and (iii) activity of the one or more second users with the file; determining that, for one or more files from the plurality of files, the score exceeds a threshold; and caching the one or more files at the client device or within a geographic region of the client device in response to determining that the score exceeds the threshold.

Example A2 is the system of Example A1, the score being computed based on at least: a device type of the client device, and a time of day and day of the week.

Example A3 is the system of Example A1, wherein caching the one or more files at the client device comprises storing the one or more files in a cache memory of the client device.

Example A4 is the system of Example A1, wherein caching the one or more files within the geographic region of the client device comprises storing the one or more files in an online data store within the geographic region of the client device.

Example A5 is the system of Example A1, wherein the geographic region of the client device comprises a continent, a country, or a metropolitan area where the client device was last online or a geographic area within a predefined threshold distance from where the client device was last online.

Example A6 is the system of Example A1, wherein the one or more second users use different client devices from the client device of the first user.

Example A7 is the system of Example A1, the operations further comprising: providing for display, at the client device, of an icon representing each of the one or more files.

Example A8 is the system of Example A1, wherein the interactions between the first user and the one or more second users comprise both the first user and the one or more second users editing or commenting on one or more common files.

Example A9 is the system of Example A1, wherein the interactions between the first user and the one or more second users comprise email messages between the first user and the one or more second users.

Example A10 is the system of Example A9, wherein the email messages include an attachment of or a hyperlink to at least one of the one or more files.

Example A11 is the system of Example A1, the operations further comprising: identifying the one or more second users based on email messages of the first user, social network contacts of the first user, or a contact list of the first user.

Example A12 is the system of Example A1, wherein the one or more files comprise word processing documents or spreadsheets.

Example A13 is the system of Example A1, wherein the one or more data repositories comprise a data repository residing at the client device and a data repository residing remotely to the client device, and wherein the one or more data repositories comprises files created by the first user, files shared with the first user, and files made accessible to the public.

Example A14 is the system of Example A1, wherein the social influencer score measures the likelihood that the first user accesses files associated with the one or more second users.

Example A15 is the system of Example A1, wherein the social influencer score measures the likelihood that other users access files associated with the one or more second users.

Example B1 is a non-transitory machine-readable medium storing instructions which, when executed by one or more machines, cause the one or more machines to perform operations comprising: computing, for each file in a plurality of files stored in one or more data repositories, a score representing a likelihood that a first user of a client device will access the file, the plurality of files being accessible to the first user and one or more second users, the score being computed based on at least: (i) interactions between the first user and the one or more second users. (ii) a social influencer score of the one or more second users, the social influencer score measuring a likelihood that the first user or other users access files associated with the one or more second users, and (iii) activity of the one or more second users with the file; determining that, for one or more files from the plurality of files, the score exceeds a threshold; and caching the one or more files at the client device or within a geographic region of the client device in response to determining that the score exceeds the threshold.

Example B2 is the machine-readable medium of Example B1, the score being computed based on at least: a device type of the client device, and a time of day and day of the week.

Example B3 is the machine-readable medium of Example B1, wherein caching the one or more files at the client device comprises storing the one or more files in a cache memory of the client device.

Example B4 is the machine-readable medium of Example B1, wherein caching the one or more files within the geographic region of the client device comprises storing the one or more files in an online data store within the geographic region of the client device.

Example B5 is the machine-readable medium of Example B1, wherein the geographic region of the client device comprises a continent, a country, or a metropolitan area where the client device was last online or a geographic area within a predefined threshold distance from where the client device was last online.

Example B6 is the machine-readable medium of Example B1, wherein the one or more second users use different client devices from the client device of the first user.

Example B7 is the machine-readable medium of Example B1, the operations further comprising: providing for display, at the client device, of an icon representing each of the one or more files.

Example B8 is the machine-readable medium of Example B1, wherein the interactions between the first user and the one or more second users comprise both the first user and the one or more second users editing or commenting on one or more common files.

Example B9 is the machine-readable medium of Example B1, wherein the interactions between the first user and the one or more second users comprise email messages between the first user and the one or more second users.

Example B10 is the machine-readable medium of Example B9, wherein the email messages include an attachment of or a hyperlink to at least one of the one or more files.

Example B11 is the machine-readable medium of Example B1, the operations further comprising: identifying the one or more second users based on email messages of the first user, social network contacts of the first user, or a contact list of the first user.

Example B12 is the machine-readable medium of Example B1, wherein the one or more files comprise word processing documents or spreadsheets.

Example B13 is the machine-readable medium of Example B1, wherein the one or more data repositories comprise a data repository residing at the client device and a data repository residing remotely to the client device, and wherein the one or more data repositories comprises files created b r the first user, files shared with the first user, and files made accessible to the public.

Example B14 is the machine-readable medium of Example B1, wherein the social influencer score measures the likelihood that the first user accesses files associated with the one or more second users.

Example B15 is the machine-readable medium of Example B1, wherein the social influencer score measures the likelihood that other users access files associated with the one or more second users.

Example C1 is a method comprising: computing, for each file in a plurality of files stored in one or more data repositories, a score representing a likelihood that a first user of a client device will access the file, the plurality of files being accessible to the first user and one or more second users, the score being computed based on at least: (i) interactions between the first user and the one or more second users, (ii) a social influencer score of the one or more second users, the social influencer score measuring a likelihood that the first user or other users access files associated with the one or more second users, and (iii) activity of the one or more second users with the file; determining that, for one or more files from the plurality of files, the score exceeds a threshold; and caching the one or more files at the client device or within a geographic region of the client device in response to determining that the score exceeds the threshold.

Example C2 is the method of Example C1, the score being computed based on at least: a device type of the client device, and a time of day and day of the week.

Example C3 is the method of Example C1, wherein caching the one or more files at the client device comprises storing the one or more files in a cache memory of the client device.

Example C4 is the method of Example C1, wherein caching the one or more files within the geographic region of the client device comprises storing the one or more files in an online data store within the geographic region of the client device.

Example C5 is the method of Example C1, wherein the geographic region of the client device comprises a continent, a country, or a metropolitan area where the client device was last online or a geographic area within a predefined threshold distance from where the client device was last online.

Example C6 is the method of Example C1, wherein the one or more second users use different client devices from the client device of the first user.

Example C7 is the method of Example C1, further comprising: providing for display, at the client device, of an icon representing each of the one or more files.

Example C8 is the method of Example C1, wherein the interactions between the first user and the one or more second users comprise both the first user and the one or more second users editing or commenting on one or more common files.

Example C9 is the method of Example C1, wherein the interactions between the first user and the one or more second users comprise email messages between the first user and the one or more second users.

Example C10 is the method of Example C9, wherein the email messages include an attachment of or a hyperlink to at least one of the one or more files.

Example C11 is the method of Example C1, further comprising: identifying the one or more second users based on email messages of the first user, social network contacts of the first user, or a contact list of the first user.

Example C12 is the method of Example C1, wherein the one or more files comprise word processing documents or spreadsheets.

Example C13 is the method of Example C1, wherein the one or more data repositories comprise a data repository residing at the client device and a data repository residing remotely to the client device, and wherein the one or more data repositories comprises files created by the first user, files shared with the first user, and files made accessible to the public.

Example C14 is the method of Example C1 wherein the social influencer score measures the likelihood that the first user accesses files associated with the one or more second users.

Example C15 is the method of Example C1, wherein the social influencer score measures the likelihood that other users access files associated with the one or more second users.

### Components and Logic

Certain embodiments are described herein as including logic or a number of components or mechanisms. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations.

Accordingly, the phrase “hardware component” should be understood to encompass a tangible record, be that an record that is physically constructed, permanently configured (e.g., hardwired), or temporarily configured (e.g., programmed) to operate in a certain manner or to perform certain operations described herein. As used herein, “hardware-implemented component” refers to a hardware component. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

### Example Machine And Software Architecture

The components, methods, applications, and so forth described in conjunction with FIGS. 1-4 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

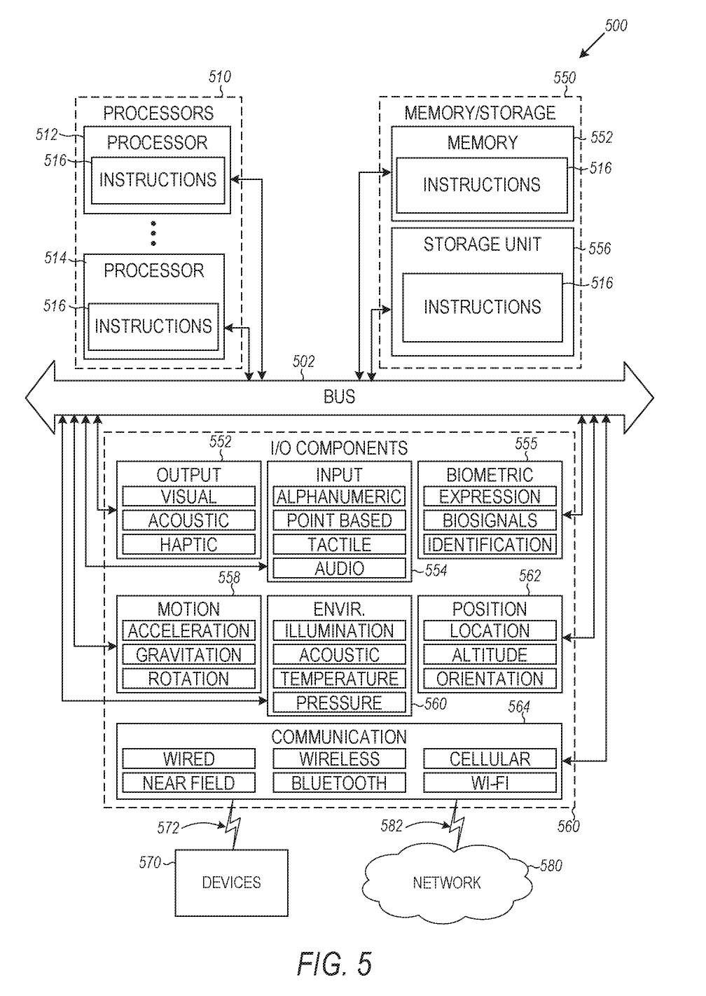

FIG. 5 is a block diagram illustrating components of a machine 500, according to some example embodiments, able to read instructions from a machine-readable medium (e.g., a machine-readable storage medium) and perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) for causing the machine 500 to perform any one or more of the methodologies discussed herein may be executed. The instructions 516 transform the general, non-programmed machine into a particular machine programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, PC, a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory/storage 530, and I/O components 550, which may be configured to communicate with each other such as via a bus 502. In an example embodiment, the processors 510 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions contemporaneously. Although FIG. 5 shows multiple processors 510, the machine 500 may include a single processor with a single core, a single processor with multiple cores (e.g., a multi-core processor), multiple processors with a single core, multiple processors with multiples cores, or any combination thereof.

The memory/storage 530 may include a memory 532, such as a main memory, or other memory storage, and a storage unit 536, both accessible to the processors 510 such as via the bus 502. The storage unit 536 and memory 532 store the instructions 516 embodying any one or more of the methodologies or functions described herein. The instructions 516 may also reside, completely or partially, within the memory 532, within the storage unit 536, within at least one of the processors 510 (e.g., within the processor's cache memory), or any suitable combination thereof, during execution thereof by the machine 500. Accordingly, the memory 532, the storage unit 53 and the memory of the processors 510 are examples of machine-readable media.

As used herein, “machine-readable medium” means a device able to store instructions (e.g., instructions 516) and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 516. The term “machine-readable medium” shall also be taken to include any medium, or combination of multiple media, that is capable of storing instructions (e.g., instructions 516) for execution by a machine (e.g., machine 500), such that the instructions, when executed by one or more processors of the machine (e.g., processors 510), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various example embodiments, the I/O components 550 may include output components 552 and input components 554. The output components 552 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the 110 components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), measure exercise-related metrics (e.g., distance moved, speed of movement, or time spent exercising) identify a person (e.g., voice identification, retinal identification, facial identification, fingerprint identification, or electroencephalogram based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or other suitable device to interface with the network 580. In further examples, the communication components 564 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., a peripheral device coupled via a USB).

Moreover, the communication components 564 may detect identifiers or include components operable to detect identifiers. For example, the communication components 564 may include Radio Frequency Identification (RFID) tag reader components, NFC smart tag detection components, optical reader components, or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

In various example embodiments, one or more portions of the network 580 may be an ad hoc network, an intranet, an extranet, a virtual private network (VPN), a local area network (LAN), a wireless LAN (NVLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolufion-Data Optimized (EVDO) technology, General Packet Radio Service (GPRS) technology, Enhanced. Data rates for GSM Evolution (EDGE) technology, third Generation Partnership Project (3GPP) including 5G, fourth generation wireless (4G) networks, Universal Mobile Telecommunications System (UMTS), High Speed Packet Access (HSPA), Worldwide interoperability for Microwave Access (WiMAX), Long Term Evolution (LTE) standard, others defined by various standard-setting organizations, other long range protocols, or other data transfer technology.

The instructions 516 may be transmitted or received over the network 580 using a transmission medium via a network interface device (e.g., a network interface component included in the communication components 564) and utilizing any one of a number of well-known transfer protocols (e.g., HTTP). Similarly, the instructions 516 may be transmitted or received using a transmission medium via the coupling 572 (e.g., a peer-to-peer coupling) to the devices 570. The term “transmission medium” shall be taken to include any intangible medium that is capable of storing, encoding, or carrying the instructions 516 for execution by the machine 500, and includes digital or analog communications signals or other intangible media to facilitate communication of such software.

What is claimed is:

1. A system comprising:
one or more hardware processors; and
a memory storing instructions which, when executed by the one or more hardware processors, cause the one or more hardware processors to perform operations comprising:
computing, for each file in a plurality of files stored in one or more data repositories, a score representing a likelihood that a first user of a client device will access the file, the plurality of files being accessible to the first user and one or more second users, the score being computed based on at least: (i) interactions between the first user and the one or more second users, (ii) a social influencer score of the one or more second users, the social influencer score measuring a likelihood that the first user or other users access files associated with the one or more second users, and (iii) activity of the one or more second users with the file;
determining that, for one or more files from the plurality of files, the score exceeds a threshold; and
caching the one or more files at the client device or within a geographic region of the client device in response to determining that the score exceeds the threshold.

2. The system of claim 1, the score being computed based on at least: a device type of the client device, and a time of day and day of the week.

3. The system of claim 1, wherein caching the one or more files at the client device comprises storing the one or more files in a cache memory of the client device.

4. The system of claim 1, wherein caching the one or more files within the geographic region of the client device comprises storing the one or more files in an online data store within the geographic region of the client device.

5. The system of claim 1, wherein the geographic region of the client device comprises a continent, a country, or a metropolitan area where the client device was last online or a geographic area within a predefined threshold distance from where the client device was last online.

6. The system of claim 1, wherein the one or more second users use different client devices from the client device of the first user.

7. The system of claim 1, the operations further comprising:
providing for display, at the client device, of an icon representing each of the one or more files.

8. The system of claim 1, wherein the interactions between the first user and the one or more second users comprise both the first user and the one or more second users editing or commenting on one or more common files.

9. The system of claim 1, wherein the interactions between the first user and the one or more second users comprise email messages between the first user and the one or more second users.

10. The system of claim 9, wherein the email messages include an attachment of or a hyperlink to at least one of the one or more files.

11. The system of claim 1, the operations further comprising:
identifying the one or more second users based on email messages of the first user, social network contacts of the first user, or a contact list of the first user.

12. The system of claim 1, wherein the one or more files comprise word processing documents or spreadsheets.

13. The system of claim 1, wherein the one or more data repositories comprise a data repository residing at the client device and a data repository residing remotely to the client device, and wherein the one or more data repositories comprises files created by the first user, files shared with the first user, and files made accessible to the public.

14. A non-transitory machine-readable medium storing instructions which, when executed by one or more machines, cause the one or more machines to perform operations comprising:
computing, for each file in a plurality of files, a score representing a likelihood that a first user of a client device will access the file, the plurality of files being accessible to the first user and one or more second users, the score being computed based on at least: (i) interactions between the first user and the one or more second users, (ii) a social influencer score of the one or more second users, the social influencer score measuring a likelihood that the first user or other users access files associated with the one or more second users, and (iii) activity of the one or more second users with the file;
determining that, for one or more files from the plurality of tiles, the score exceeds a threshold; and
caching the one or more files at the client device or within a geographic region of the client device in response to determining that the score exceeds the threshold.

15. The machine-readable medium of claim 14, wherein the social influencer score measures the likelihood that the first user accesses files associated with the one or more second users.

16. The machine-readable medium of claim 14, wherein the social influencer score measures the likelihood that other users access files associated with the one or more second users.

17. The machine-readable medium of claim 14, the score being computed based on at least: a device type of the client device, and a time of day and day of the week.

18. The machine-readable medium of claim 14, wherein caching the one or more files at the client device comprises storing the one or more files in a cache memory of the client device.

19. The machine-readable medium of claim 14, wherein caching the one or more files within the geographic region of the client device comprises storing the one or more files in an online data store within the geographic region of the client device.

20. A method comprising:
computing, for each file in a plurality of files, a score representing a likelihood that a first user of a client device will access the file, the plurality of files being accessible to the first user and one or more second users, the score being computed based on at least: (i) interactions between the first user and the one or more second users, (ii) a social influencer score of the one or more second users, the social influencer score measuring a likelihood that the first user or other users access files associated with the one or more second users, and (iii) activity of the one or more second users with the file;
determining that, for one or more files from the plurality of files, the score exceeds a threshold; and
caching the one or more files at the client device in response to determining that the score exceeds the threshold.
